(19) United States
(12) Patent Application Publication
(10) Pub. No.: US 2022/0193941 A1
(43) Pub. Date: Jun. 23, 2022

(54) RATCHETING PVC CUTTER WITH QUICK RELEASE BLADE MECHANISM

(71) Applicant: OLYMPIA TOOLS INTERNATIONAL, INC., Covina, CA (US)

(72) Inventors: Cecil WILSON, Sanford, NC (US); Jonathan S. BECKWITH, Durham, NC (US)

(21) Appl. No.: 17/127,577

(22) Filed: Dec. 18, 2020

(51) Int. Cl. B26D 3/16; B26B 13/28

(52) U.S. Cl. CPC B26D 3/169; B26B 13/28

(57) ABSTRACT

A pipe cutting tool includes a tool body having a handle portion and a blade carrying portion with a tool body hole extending through the blade carrying portion. The pipe cutting tool includes a blade carriage coupled to the tool body and rotatable around the tool body hole and a blade which engages with the blade carriage. The pipe cutting tool includes at least one retaining plate coupled to the blade carriage and rotatable about the tool body hole. The pipe cutting tool includes a pin which is configured to removably extend through the tool body hole and a hole formed through the blade carriage. The tool body includes a boss feature which engages with the retaining plate to hold the blade carriage when the pin is removed from the pipe cutting tool.

### BACKGROUND

Embodiments described herein generally relate to a pipe cutting tool, more particularly, embodiments relate to a ratcheting cutting tool with a quick release blade.

Ratcheting cutting tools are commonly used for cutting pipes (e.g., plastic, PVC, CPVC, PEX, vinyl, rubber, and multilayer pipes, among others), cables (e.g., aircraft cable, extra high strength guy strand, wire rope, and stainless steel cable), rods, and light wires, among other materials.

Some pipe cutting tools have a blade which is screwed to the tool body, e.g., the handle and/or blade carriage. In such cases, blade replacement requires using a screwdriver to remove the screw holding the blade in place. Some other pipe cutting tools have a blade which is only removable from the tool body when the cutting tool is in the fully closed position. There is a need for a pipe cutting tool with an improved quick release blade. Embodiments of the present disclosure overcome at least some of these issues.

### SUMMARY

Embodiments of the present disclosure generally relate to a cutting tool, more particularly, embodiments relate to a ratcheting pipe cutting tool with a quick release blade.

Embodiments of the present disclosure relate to a pipe cutting tool, comprising: a tool body having a handle portion and a blade carrying portion, the blade carrying portion including a tool body hole extending therethrough; a blade carriage coupled to the tool body and rotatable around the tool body hole, the blade carriage having a blade carriage hole extending therethrough and a blade recess; a blade having a cutting portion and a tang shaped to fit in the blade recess, the tang including a notch; a boss feature extending from the tool body around the tool body hole; and a pin configured to removably extend through the tool body hole and the blade carriage hole, wherein: when the pin is positioned extending through the blade carriage hole, the pin engages the notch of the tang to secure the blade to the blade carriage; when the pin is removed from the blade carriage hole, the blade is released from the blade carriage and can be removed; and the boss feature engages the blade carriage so that the blade carriage is held in place in the tool body when the pin is removed from the blade carriage hole.

Embodiments of the present disclosure relate to a quick release mechanism for a pipe cutting tool, the quick release mechanism comprising: a tool body having a handle portion and a blade carrying portion, the blade carrying portion including a tool body hole extending therethrough along a first axis; a blade carriage coupled to the tool body and rotatable around the tool body hole about the first axis, the blade carriage having a blade carriage hole extending therethrough along the first axis and a blade recess; a blade having a cutting portion and a tang shaped to fit in the blade recess, the tang including a notch; and a pin configured to be selectively removed from the tool body hole and the blade carriage hole along the first axis, wherein the pin includes: an elongated body having: a first outer diameter; a first end; and a second end opposite the first end; a pin head disposed near the first end of the elongated body, wherein the pin head is configured to engage with the tool body when the pin is positioned extending through the tool body hole and the blade carriage hole; a ball plunger disposed in the first outer diameter of the elongated body at the second end, wherein the ball plunger prevents the pin from being removed from the tool body hole and the blade carriage hole when the pin is positioned extending through the tool body hole and the blade carriage hole; and a pull ring disposed on the pin head; wherein: the pin is removable from the tool body hole and the blade carriage hole by displacing the ball plunger of the pin and pulling the pull ring along the first axis; and when the pin is removed from the tool body hole and the blade carriage hole, the blade is released from the blade carriage and can be removed.

Embodiments of the present disclosure relate to a method of changing a blade in a pipe cutting tool, the method comprising: moving a pin along a first axis from a locked position to a removed position, wherein in the locked position, the pin extends through a pipe cutting tool having: a tool body having a handle portion and a blade carrying portion, the blade carrying portion including a tool body hole extending therethrough along the first axis; a blade carriage coupled to the tool body and rotatable around the hole of the tool body, the blade carriage having a blade carriage hole extending therethrough along the first axis and a blade recess; a blade having a cutting portion and a tang shaped to fit in the blade recess, the tang including a notch; and a boss feature extending from the tool body around the tool body hole; wherein the pin is configured to removably extend through the tool body hole and the blade carriage hole, wherein: when the pin is positioned in the locked position, the pin engages the notch of the tang to secure the blade to the blade carriage; when the pin is in a removed position, the blade is released from the blade carriage and can be removed; and the boss feature extends from the tool body hole and engages the blade carriage so that the blade carriage is secured to the tool body when the pin is removed from the hole; removing the blade from the blade carriage by moving the blade along a second axis orthogonal to the first axis; placing a second blade in the blade carriage by moving the second blade along the second axis orthogonal to the first axis; and moving the pin along the first axis to the locked position to secure the blade to the blade carriage.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a top isometric view of an exemplary cutting tool, according to one or more embodiments.

FIG. 1B is an exploded top isometric view of the exemplary cutting tool, according to one or more embodiments.

FIG. 2A is a top isometric view a blade and a blade carriage of the exemplary cutting tool, according to one or more embodiments.

FIG. 2B is a top isometric view of the blade, the blade carriage, and retaining plates of the exemplary cutting tool, according to one or more embodiments.

FIG. 3A is a top isometric view of a tool body portion of the exemplary cutting tool, according to one or more embodiments.

FIG. 3B is a top isometric view of a raised boss of the tool body portion of the exemplary cutting tool, according to one or more embodiments.

FIGS. 4A-4C are isometric views of a master pin of the exemplary cutting tool, according to one or more embodiments.

FIGS. 4D-4F are elevation views of the master pin of the exemplary cutting tool, according to one or more embodiments.

FIG. 5A is a side elevation view of the exemplary cutting tool with the blade in an open position, according to one or more embodiments.

FIG. 5B is a side elevation view of the exemplary cutting tool with the blade in between the open position and a closed position, according to one or more embodiments.

FIG. 5C is a side elevation view of the exemplary cutting tool with the blade in the closed position, according to one or more embodiments.

FIG. 6 is a top isometric view of the exemplary cutting tool in the open position with the master pin inserted, according to one or more embodiments.

FIG. 7 is a top isometric view of the exemplary cutting tool with the master pin removed from the tool body, according to one or more embodiments.

FIG. 8 is a top isometric view of the exemplary cutting tool with the master pin and the blade removed from the tool body, according to one or more embodiments.

FIG. 9 is a flow chart illustrating a method for using the quick release mechanism of the cutting tool, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to a pipe cutting tool, more particularly, embodiments relate to a ratcheting pipe cutting tool with a quick release blade. Pipe cutting tools of the present disclosure may be used for cutting pipes formed from plastic, PVC, CPVC, PEX, vinyl, rubber, and other similar materials. Although the apparatus and method described herein relate to a pipe cutting tool, the pipe cutting tool may be used to cut other types of materials.

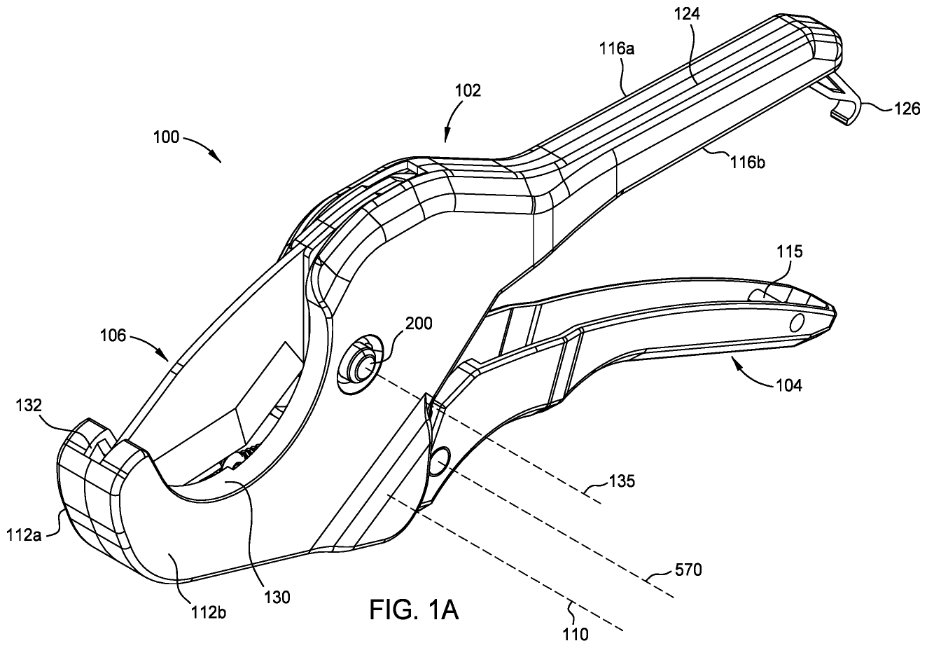

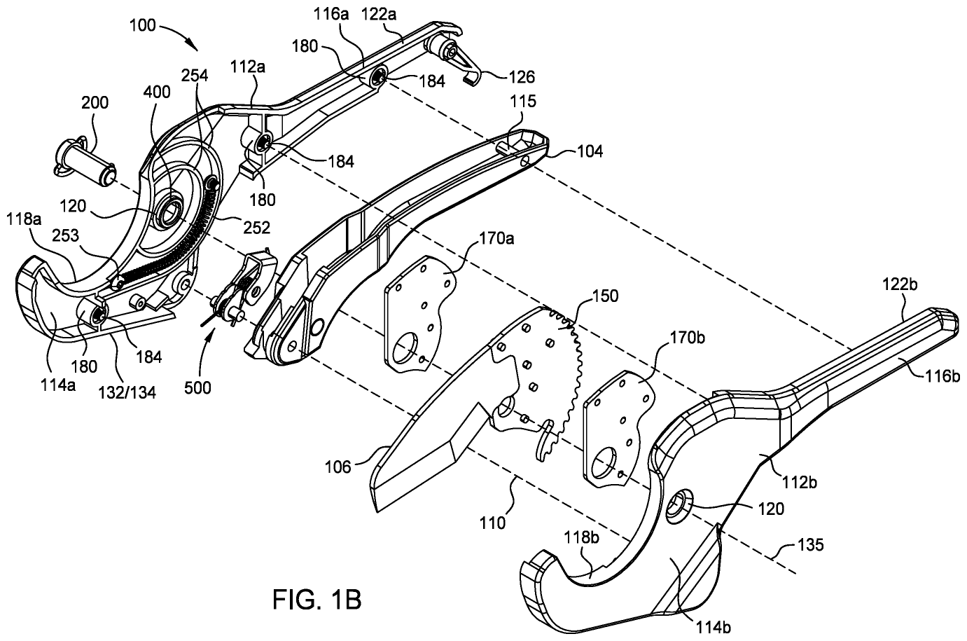

FIG. 1A is a top isometric view of an exemplary cutting tool 100. FIG. 1B is an exploded isometric view of the cutting tool 100 of FIG. 1A. Referring to FIGS. 1A-1B, the exemplary cutting tool 100 includes a tool body 102 pivotally coupled, at a first axis 110, with a first handle 104, and a blade 106 which rotates about a second axis 135. As illustrated in FIG. 1B, the tool body 102 includes tool body portions 112a, 112b each having blade carrying portions 114a, 114b, handle portions 116a, 116b, and tool body holes 120 formed therethrough along the second axis 135. The blade carrying portions 114a, 114b are defined by rounded portions 118a, 118b which form an inset 130 for receiving pipes, cables, light wires, or other elongated, cylindrical materials to be cut by the cutting tool 100. It is contemplated that inset 130 may be of different sizes in different embodiments to accommodate variously sized pipes, cables, light wires, or other elongated materials to be cut by the exemplary cutting tool 100. It is also contemplated that the pipe cutting too may accommodate other types of materials which are not cylindrical in shape. It is further contemplated that tool body portions 112a, 112b may be further defined by a lower flat edge 134 for resting the cutting tool 100 on a flat surface, such as the ground or a table, when the cutting tool 100 is not being used.

With specific reference to FIG. 1B, tool body portions 112a, 112b are joined together via bolts 184 inserted through bolt holes 180 of tool body portion 112a. The bolts 184 engage with respective receiving ends (not shown) disposed on the inner side of tool body portion 112b. When joined, tool body portions 112a, 112b form a slot 132 in the tool body 102. The slot 132 is formed between the tool body portions 112a, 112b and extends along the arcuate inset 130 for receiving and housing a blade 106 and a blade carriage 150. As further described below, the blade 106 and blade carriage 150 are rotatable between an open position where the blade 106 is not in the slot 132 of the tool body 102 to a closed position where the blade is within the slot 132 of the tool body 102.

The handle portions 116a, 116b of the tool body 102 are defined by elongated ends 122a, 122b forming a second handle 124. The second handle 124 of the tool body 102 is gripped during cutting operations of the pipe cutting tool 100. In combination with the second handle 124, the first handle 104 may be used to ratchet the blade 106 about the second axis 135. The cutting operations of the tool 100 will be discussed in greater detail below. The second handle 124 includes a handle latch 126 housed within the elongated ends 122a, 122b. As illustrated in FIGS. 1A and 1B, the handle latch 126 is a hook latch which engages a latch pin 115 disposed within the body of the first handle 104. When the handle latch 126 is engaged with the latch pin 115 of the first handle 104, the second handle 104 is prevented from rotating about the first axis 110 which prevents the blade 106 from rotating about the second axis 135.

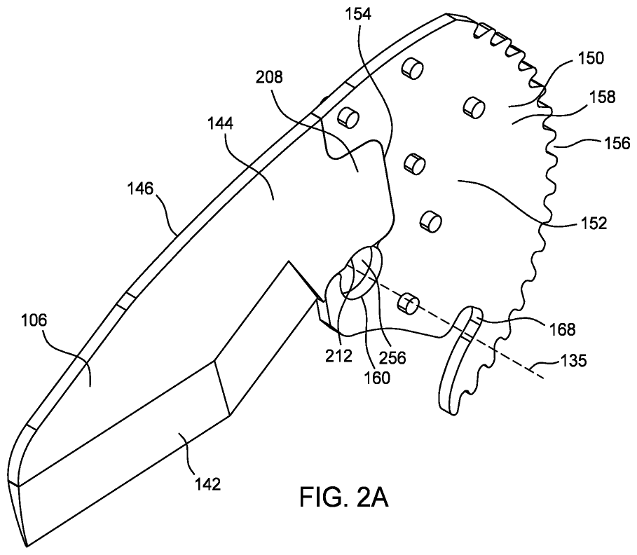

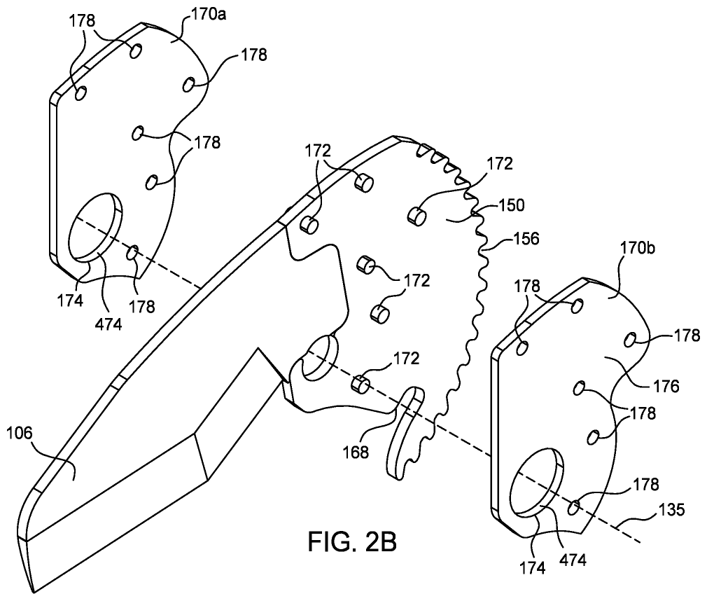

With reference to FIG. 2A, the cutting tool 100 includes a blade carriage 150 housed within the cutting tool 100 and shaped to fit the blade 106. As shown, the blade carriage 150 is an irregularly shaped plate having a main body portion 152, a first recess 154 formed therein, and a plurality of teeth 156 disposed along a crescent shaped edge 158. The first recess 154 of the blade carriage 150 is formed in the main body portion 152 of the blade carriage 150 above a second recess 160 disposed around the second axis 135. The second recess 160 is arcuate in shape and sized to receive a master pin 200 along the second axis 135. The blade carriage 150 includes a holding recess 168 formed near the crescent shaped edge 158 to hold the blade carriage 150 when a ratcheting mechanism of the cutting tool 100 is disengaged from the plurality of teeth 156. The ratcheting and cutting operations of the blade carriage 150 and cutting tool 100 are described in detail below.

The blade carriage 150 is rotatable about the second axis 135 and is housed within the slot 132 formed between the tool body portions 112a, 112b. The blade carriage 150 is rotatably coupled to the tool body portion 112a by a spring 252. At one end the spring 252 is connected to the main body portion 152 of the blade carriage 150 via a fastener (not shown). At the opposite end, the spring 252 is secured to the inner side of the tool body portion 112a via another fastener 253 which is disposed below the inset 130. To maintain a desirable orientation of the spring 252 during cutting and ratcheting operations, the spring 252 is housed within a series of concentric raised edges 254 formed in the tool body portions 112a, 112b.

With continued reference to FIG. 1B and FIGS. 2A-2B, the blade 106 includes a cutting portion 142, a main body portion 144 defined by an outer edge 146, and a tang 208 shaped to fit in the first recess 154 of the blade carriage 150. A notch 212 is formed along an edge of the tang 208. In some other embodiments (not shown), instead of the notch 212, a hole is disposed through the tang 208 for receiving the master pin 200. When the blade 106 is placed into the blade carriage 150, the tang 208 engages with the first recess 154 to primarily hold the blade 106 within the tool body 102. Accordingly, when the blade 106 is engaged with the tang 208, the notch 212 and the second recess 160 of the blade carriage 150 form a hole 256 about the second axis 135 which receives the master pin 200 to secure the blade 106 to the blade carriage 150 and the tool body 102.

Referring now to FIG. 2B, the exemplary cutting tool 100 further includes a pair of retaining plates 170a, 170b disposed on either side of the blade carriage 150. The retaining plates 170a, 170b are joined to the blade carriage 150 via a plurality of pins 172 formed in the blade carriage 150. The retaining plates 170a, 170b are rotatable with the blade carriage 150 about the second axis 135. The plurality of pins 172 are received by an equal number of recesses 178 formed in the body 176 of the retaining plates 170a, 170b. The retaining plates 170a, 170b and the blade carriage 150 are rotatably coupled to the tool body portion 112a by the spring 252 which is coupled to the retaining plate 170a via a fastener (not shown).

Retaining plates 170a, 170b each include a retaining plate hole 174 disposed about the second axis 135 of the tool 100. The retaining plate hole 174 is in axial alignment with the tool body hole 120 and the hole 256 formed by the notch 212 and the second recess 160 of the blade carriage 150 when the blade 106 is positioned in the blade carriage 150. In certain embodiments, the retaining plate hole 174 has a diameter greater than the diameter of the tool body hole 120. In some embodiments, the retaining plate hole 174 has a diameter greater than the diameter of the hole 256.

With reference back to FIGS. 1A-1B and continued reference to FIGS. 2A-2B, the blade carriage 150 and the retaining plates 170a, 170b house the blade 106 during tool operation. As illustrated, the first recess 154 formed in the main body portion 152 of the blade carriage 150 receives the tang 208 of the blade 106. During tool operation, the retaining plates 170a, 170b prevent the blade 106 from moving laterally in a direction along the second axis 135 within the tool body 102. When the master pin 200 is moved along the second axis 135 through the tool body hole 120 and engages the notch 212, the blade 106 is prevented from being removed from the blade carriage 150 along an axis (not shown) orthogonal to the second axis 135 and aligned with the slot 132. Accordingly, when the master pin 200 is removed from the tool body hole 120 along the second axis 135 the blade 106 may be removed from the blade carriage 150 and thus removed from the cutting tool 100.

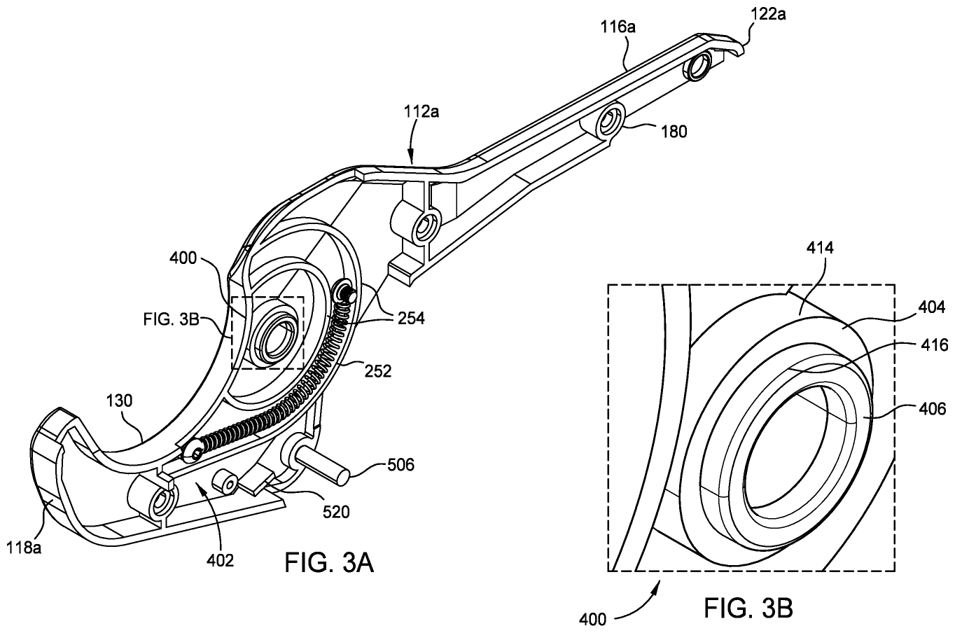

As further illustrated FIGS. 3A-3B, the tool body portions 112a, 112b each include a raised boss 400 concentrically formed around the second axis 135 on the inner side 402 of the tool body portions 112a, 112b. The raised boss 400 of the tool body portion 112a is illustrated in FIGS. 3A-3B and described herein. The raised boss 400 includes a first raised surface 404 having a first outer diameter 414 and a second raised surface 406 having a second outer diameter 416. The second raised surface 406 extends from the tool body portion 112a inwardly past the first raised surface 404 along the second axis 135. The raised boss 400 is disposed within the concentric raised edges 254 of the tool body portions 112a, 112b.

The raised boss 400 of each tool body portion 112a, 112b engages with the retaining plate hole 174 of each retaining plate 170a, 170b to hold and support the retaining plates 170a, 170b and the blade carriage 150 during tool operations and when the master pin 200 is removed from the cutting tool 100. For example, the second outer diameter 416 of the second raised surface 406 engages with an inner diameter 474 of the retaining plate hole 174 to support the blade carriage 150 when the master pin 200 is removed from the tool body 102. Contact between the raised boss 400 and the retaining plates 170a, 170b maintains the blade carriage 150 properly positioned within the tool body 102. The second raised surface 406 engages with the blade carriage 150 and the blade 106 to provide additional lateral support and prevent the blade carriage 150 from moving laterally during cutting and ratcheting operations.

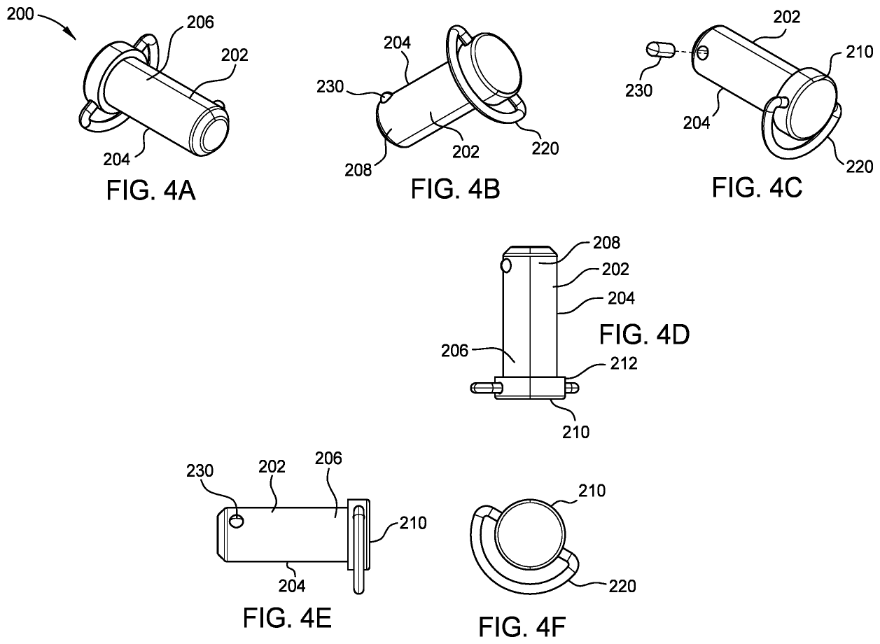

Turning to FIGS. 4A-4F, an exemplary embodiment of the master pin 200 is described in detail below. Generally, the master pin 200 includes a cylindrical, elongated body 202 having a first outer diameter 204, a first end 206, and a second end 208. The master pin 200 has a pin head 210 disposed at the first end 206. The pin head 210 is cylindrical in shape with a second outer diameter 212. The second outer diameter 212 is greater than the first outer diameter 204 of the elongated body 202 to facilitate removal of the master pin 200 from the cutting tool 100. The master pin 200 has a pull ring 220 disposed in the second outer diameter 212 of the pin head 210. The pull ring 220 is used to pull the master pin 200 from the tool body 102 and release the blade 106 from the blade carriage 150. The removal of the master pin 200 is described in more detail below. The master pin 200 includes a ball plunger 230 disposed in the first outer diameter 204 of the elongated body 202 near the second end 208. The ball plunger 230 prevents the master pin 200 from being removed from the tool body 102 by engaging with the tool body 102.

With reference back to FIG. 1B, the elongated body 202 of the master pin 200 extends through the first tool body portion 112a via the tool body hole 120, the first retaining plate hole 174a, the hole 256 formed by the second recess 160 of the blade carriage 150 and the notch 212 formed in the blade, the second retaining plate hole 174b, and the tool body hole 120 of the second tool body portion 112b. As described herein, when the elongated body 202 of the master pin 200 is fully extended through the cutting tool 100, the elongated body 202 of the master pin 200 engages with the notch 212 and the second recess 160 of the blade carriage 150 to secure the blade 106 to the blade carriage 150. Accordingly, when the master pin 200 is removed from the cutting tool 100, the blade 106 may be removed from the blade carriage 150 and the tool body 102. A new blade (not shown) may be inserted into the blade carriage 150 and subsequently locked into place by the master pin 200.

It will be appreciated by one skilled in the art that the master pin 200 serves to secure the blade 106 to the blade carriage 150 and the tool body 102 and additionally acts as the primary point of rotation for the blade 106 and blade carriage 150 during cutting and ratcheting operations of the cutting tool 100. During cutting and ratcheting operations, the blade 106 and blade carriage 150 incrementally rotate about the master pin 200 and the second axis 135.

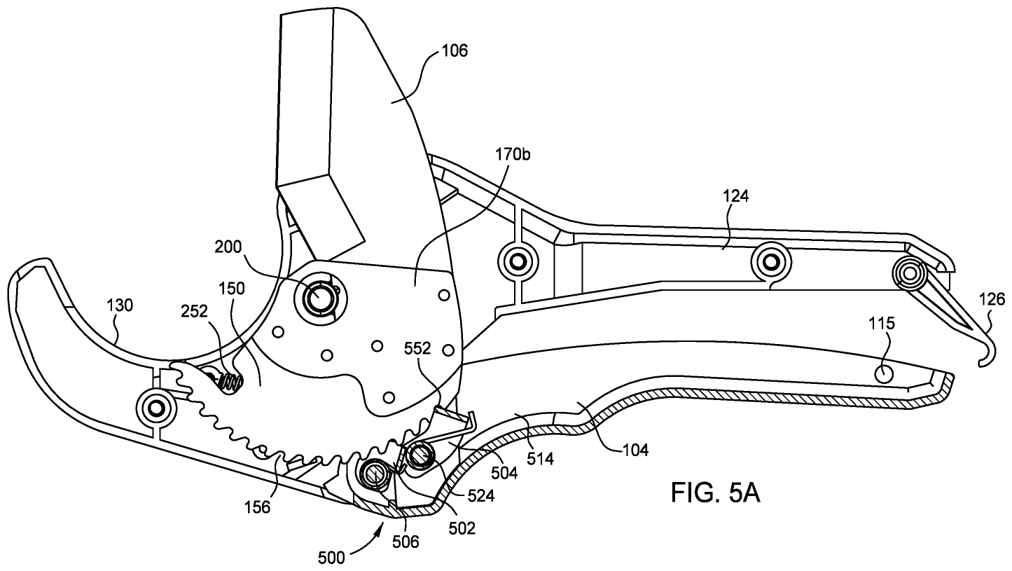

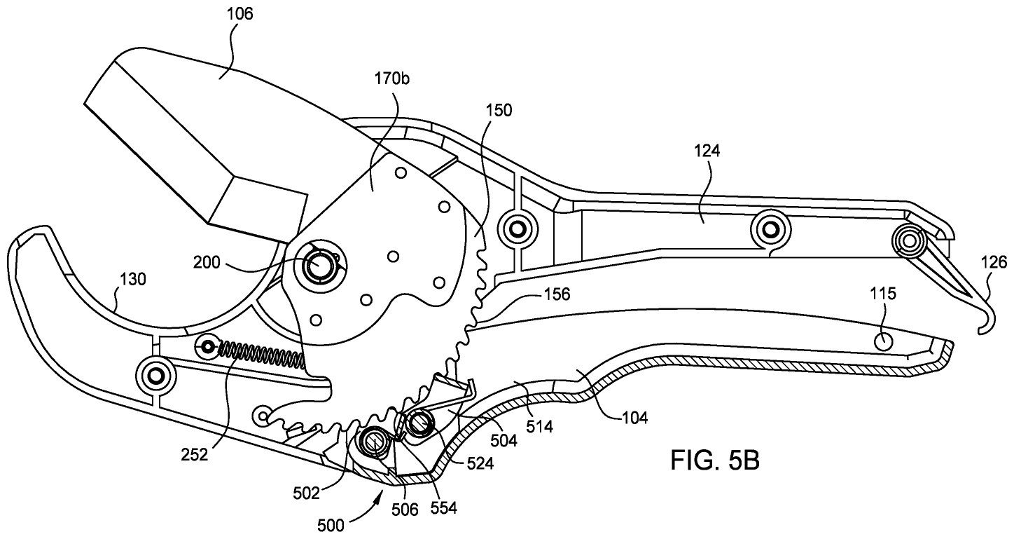

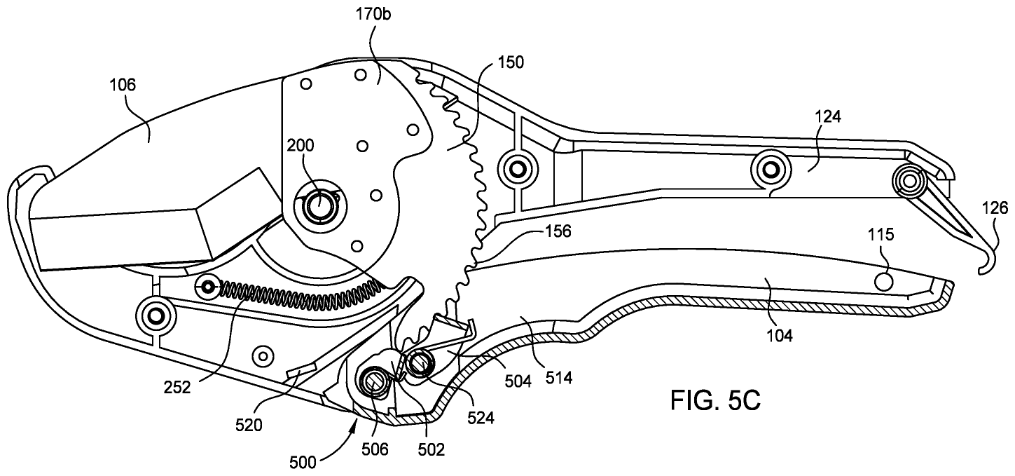

FIGS. 5A-5C illustrate the ratcheting and cutting operation of the cutting tool 100. During such operations, the blade 106 is incrementally rotated from an open position (FIG. 5A) to a closed position (FIG. 5C) using a ratcheting mechanism 500. In the illustrated embodiments, the ratcheting mechanism 500 includes a holding pawl 502 and a driving pawl 504 working in conjunction with the first handle 104. In general, the ratcheting mechanism 500 is actuated by rotating the first handle 104 relative to the tool body 102 about the first axis 110. Each of the first handle 104 and the holding pawl 502 are rotatably coupled to the tool body 102 via a first pin 506 which is disposed through the body 514 of the first handle 104 along the first axis 110. The driving pawl 504 is coupled to the first handle 104 by a second pin 524 disposed along a driving pawl axis 570 (FIG. 1A). The first pin 506 and the second pin 524 allow the holding pawl 502 and the driving pawl 504 to independently rotate about the first axis 110 and the driving pawl axis 570, respectively.

During cutting and ratcheting operations, the blade 106 and blade carriage 150 start in the open position (FIG. 5A) with the holding pawl 502 disengaged from the plurality of teeth 156 of the blade carriage 150. In use, the first handle 104 of the tool 100 is repeatedly rotated towards and away from the handle portion 116 to operate the ratcheting mechanism 500 in order to ratchet the blade carriage 150 towards the closed position (FIG. 5C) for cutting a pipe.

The operation of the ratcheting mechanism 500 will now be described in greater detail. When the first handle 104 is rotated towards the handle portion 116, the driving pawl 504 engages with a first tooth 552 of the blade carriage 150 causing the blade carriage 150 to rotate towards the closed position (e.g., in a counterclockwise direction as shown in FIGS. 5A-5C). The driving pawl 504 is biased towards the crescent shaped edge 158 of the blade carriage 150 by a torsion spring. As the blade carriage 150 rotates about the second axis 135, the holding pawl 502 engages with a second tooth 554. The holding pawl 502 is similarly biased towards the crescent shaped edge 158 of the blade carriage 150 by a torsion spring. When the first handle 104 is released, the holding pawl 502 which is engaged with the second tooth 554 of the blade carriage holds the blade 106 and blade carriage 150 in an intermediate position (FIG. 5B) between the open position (FIG. 5A) and the closed position (FIG. 5C). Moving the first handle 104 away from the handle portion 116 causes the driving pawl 504 to disengage from the plurality of teeth 156 of the blade carriage 150 when the holding pawl 502 is engaged and holding the second tooth 554. The operation is repeated with the driving pawl 504 engaged with another one of the plurality of teeth 156 such that moving the first handle 104 towards the handle portion 116 rotates the blade 106 and blade carriage 150 about the second axis 135 further towards the closed position (FIG. 5C). As the blade carriage 150 rotates about the second axis 135, the holding pawl 504 disengages from the second tooth 554 and reengages with another one of the plurality of teeth 156 to hold the blade carriage 150 and blade 106 in another intermediate position between the open position (FIG. 5A) and closed position (FIG. 5C). This ratcheting operation may be continued until the blade carriage 150 and blade 106 reach the closed position (FIG. 5C) to cut a piece of tubing inserted into the inset 130 of the cutting tool 100.

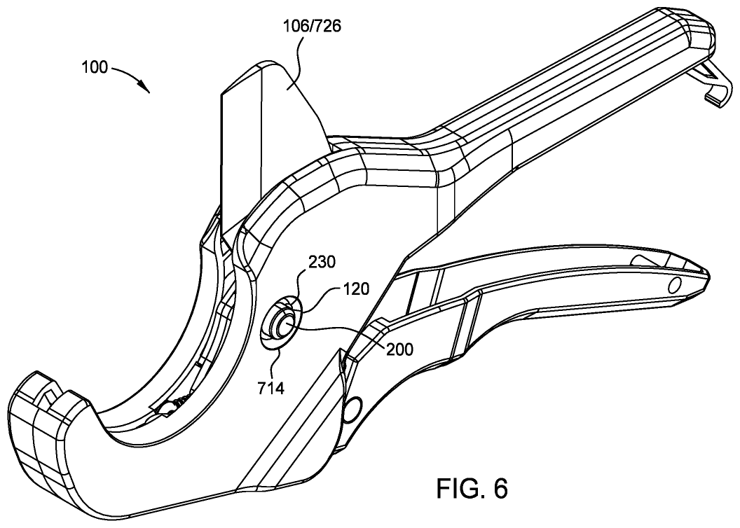

Referring still to FIGS. 5A-5C and FIG. 6, when the blade 106 is incrementally moved from the open position to the closed position using the ratcheting mechanism 500, the spring 252 is elongated by the rotation of the blade carriage 150 about the second axis 135. Accordingly, when the first handle 104 is moved to release the holding pawl 502 from contact with the plurality of teeth 156 disposed along the crescent shaped edge 158 of the blade carriage, the spring 252 returns to its original position (FIG. 5A) and rotates the blade 106 and blade carriage 150 back to the open position (FIG. 5A). To prevent the blade 106 and blade carriage 150 from moving beyond the open position about the second axis 135, at least one tool body portion 112a, 112b includes a catch mechanism 520 (FIG. 3A) extending from the inner side 402 of the tool body portion 112a, 112b. The catch mechanism 520 engages with the holding recess 168 of the blade carriage 150 when the blade 106 and blade carriage 150 are in the open position. In some embodiments, the blade carriage 150 and blade 106 may be returned to the open position at any point when the blade carriage 150 and blade 106 are between the open and closed positions (such as illustrated in FIG. 5B).

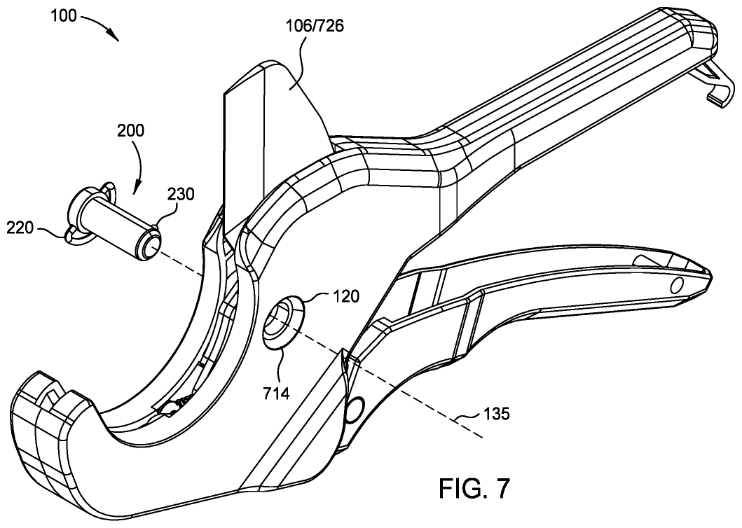

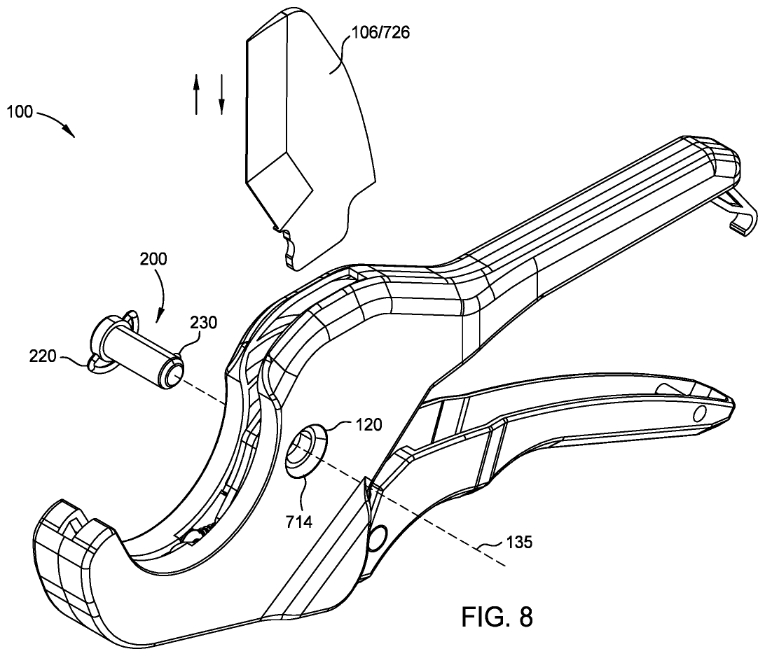

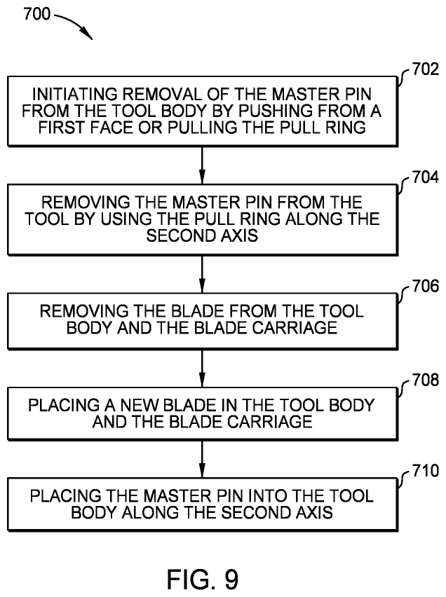

FIGS. 6-8 illustrate the cutting tool 100 at different stages of a method 700 for changing the blade 106, as further illustrated by the flow chart of FIG. 9. Apparatus and methods of the present disclosure may be used to remove and replace the blade 106 when the blade 106 becomes dull. Apparatus described herein for removing and replacing the blade 106 according to the method 700 may be referred to as a quick release mechanism. At operation 702, removal of the master pin 200 is initiated either by pushing from a first face 714 of the second tool body portion 112b or pulling using the pull ring 220 (FIG. 7). The master pin 200 includes a ball plunger 230 disposed in the first outer diameter 204 of the elongated body 202 near the second end 208. At operation 702, the ball plunger 230 is moved from a radially extended position to the radially retracted position by contacting the inner edge (not shown) of the tool body hole 120 as the master pin 200 is pushed along the second axis 135. Moving the ball plunger 230 to the radially retracted position, unlocks the master pin 200 for removal from the tool body 102 of the cutting tool 100 along the second axis 135.

At operation 704, with the ball plunger 230 in the radially retracted position, the master pin 200 is removed using the pull ring 220 disposed in the pin head 210 by pulling the master pin 200 along the second axis 135 away from the tool body 102. When the master pin 200 is removed from the tool body 102, the elongated body 202 of the master pin 200 is disengaged from the notch 212 of the blade 106 and allows the blade 106 to be removed from the blade carriage 150. It is contemplated that the master pin 200 does not need to be completely removed from the cutting tool 100 to release the blade 106 from the blade carriage 150. For example, the master pin 200 may be along the second axis 135 to a position in which the second end 208 remains in the tool body portion 112a, but the first outer diameter 204 of the master pin 200 is disengaged with the notch 212 of the blade 106 as to allow the blade 106 to be removed from the blade carriage 150. At operation 704, when the master pin 200 is removed from the tool body 102, the blade carriage 150 and retaining plates 170a, 170b are supported by the raised bosses 400 of the tool body portions 112a, 112b so as to secure the blade carriage 150 to the tool body 102.

At operation 706, the blade 106 is removed from the tool body 102 by removing the blade 106 from the blade carriage 150 through the slot 132. The blade 106 may be removed from the blade carriage 150 along an axis (not shown) orthogonal to the second axis 135 and aligned with the slot 132. Similar to operation 704, the raised boss 400 is engaged with the retaining plates 170a, 170b to support the blade carriage 150 when the blade 106 is removed from the tool body 102. At operation 708, a new blade 726 is positioned into the tool body 102 along through the slot 132. It is contemplated that the new blade 726 may be of substantially the same shape as blade 106 so as to engage with the second recess 160 of the blade carriage 150. At operation 710, the master pin 200 is placed into the tool body 102 by moving the master pin 200 along the second axis 135. Accordingly, the elongated body 202 of the master pin 200 will be pushed through the tool body holes 120, the retaining plate hole 174, the hole 256 formed by the notch 210 of the new blade 726 and the second recess 160 of the blade carriage 170 to secure the new blade 726 to the blade carriage 150. The master pin 200 is moved along the second axis 135 until the pin head 210 contacts a second face 712 of the tool body 102. When the master pin 200 is fully inserted into the tool body 102, the second end 108 extends past the tool body hole 120 of the second tool body portion 102 similar to the position of the master pin 200 at operation 702. Accordingly, the ball plunger 230, which is in the radially retracted position as the master pin 200 is moved along the second axis 135, moves to the radially extended position to lock the master pin 200 into the tool body 102.

In operation, the method 700 allows a user of the exemplary cutting tool 100 to quickly replace blades 106 by removing the master pin 200 from the tool body 102 without having to remove the entire blade carriage 150. Additionally, no other tools are required to remove the master pin 200 from the tool body 102 and may be easily and quickly removed by pushing the master pin 200 from the first face 714 of the tool body 102 and/or pulling the pull ring 220 to remove the master pin along the second axis 135.

In the illustrated embodiments, the first outer diameter 202 of the master pin 200 engages the notch 210 formed in the tang 208 of the blade 106. However, the blade 106 is not so limited. For example, the master pin 200 may fit into a corresponding hole which is formed through the blade 106 and spaced from an edge of the blade 106. In the illustrated embodiments, the blade 106 and the blade carriage 150 are separate pieces. However, the blade 106 is not so limited. For example, the blade 106 and blade carriage may be a single integral piece which is removable from the tool body 102. In the illustrated embodiments, the blade 106 is secured to the blade carriage 150 through the combination of the master pin 200 and the notch 210 of the blade 106 and second recess 160 of the blade carriage 150. However, the securing mechanism is not particularly limited to the illustrated embodiments. For example, a secondary pin may fit into corresponding holes formed through the blade 106 and the blade carriage 150. The tool body 102 may include an arc shaped groove for enabling the secondary pin to rotate about the second axis 135. The secondary pin provides a secondary contact in place of the corresponding shapes of the blade 106 and the blade carriage 150.

Embodiments of the present disclosure further relate to any one or more of the following paragraphs 1-20:

1. A pipe cutting tool, comprising: a tool body having a handle portion and a blade carrying portion, the blade carrying portion including a tool body hole extending therethrough; a blade carriage coupled to the tool body and rotatable around the tool body hole, the blade carriage having a blade carriage hole extending therethrough and a blade recess; a blade having a cutting portion and a tang shaped to fit in the blade recess, the tang including a notch; a boss feature extending from the tool body around the tool body hole; and a pin configured to removably extend through the tool body hole and the blade carriage hole, wherein: when the pin is positioned extending through the blade carriage hole, the pin engages the notch of the tang to secure the blade to the blade carriage; when the pin is removed from the blade carriage hole, the blade is released from the blade carriage and can be removed; and the boss feature engages the blade carriage so that the blade carriage is held in place in the tool body when the pin is removed from the blade carriage hole.

2. The pipe cutting tool of paragraph 1, wherein the notch of the blade is formed along an outer edge of the blade.

3. The pipe cutting tool of paragraphs 1-2, wherein the notch of the blade comprises a hole spaced from the outer edge of the blade.

4. The pipe cutting tool of paragraphs 1-3, further comprising a retaining plate coupled to the blade carriage and rotatable around the tool body hole, the retaining plate having a retaining plate hole extending therethrough, wherein the boss feature extends into the retaining plate hole to engage the blade carriage.

5. The pipe cutting tool of paragraphs 1-4, wherein the boss feature comprises: a raised surface extending from the blade carrying portion of the tool body around the tool body hole; an inner diameter configured to receive the pin when the pin is positioned extending through the tool body hole; and an outer diameter; wherein: the retaining plate hole is configured to receive the outer diameter of the boss feature; and the raised surface of the boss feature is configured to engage the blade carriage to support the blade carriage when the pin is removed from the pipe cutting tool.

6. The pipe cutting tool of paragraphs 1-5, further comprising: a second handle portion rotatably coupled to the blade carrying portion of the tool body, further comprising: a drive pawl; and a holding pawl; wherein the drive pawl and the holding pawl are configured to engage with a plurality of teeth disposed on the blade carriage to incrementally rotate the blade towards a closed position.

7. The pipe cutting tool of paragraphs 1-6, wherein the holding pawl is configured to disengage from the plurality of teeth when the second handle portion is rotated away from the handle portion of the tool body to a reset position; wherein, when the holding pawl is disengaged from the plurality of teeth, the blade and blade carriage are configured to rotate within the tool body to an open position.

8. The pipe cutting tool of paragraphs 1-7, wherein the pin includes: an elongated body having: a first outer diameter; a first end; and a second end opposite the first end; a pin head disposed at the first end of the elongated body and configured to engage with the tool body when the pin is positioned extending through the tool body hole and the blade carriage hole, wherein the pin head has a second outer diameter greater than the first outer diameter; a ball plunger disposed in the first outer diameter of the elongated body near the second end, wherein the ball plunger is configured to prevent the pin from being removed from the blade carriage hole when the pin is positioned extending through the tool body hole and the blade carriage hole; and a pull ring disposed on the pin head.

9. A quick release mechanism for a pipe cutting tool, the quick release mechanism comprising: a tool body having a handle portion and a blade carrying portion, the blade carrying portion including a tool body hole extending therethrough along a first axis; a blade carriage coupled to the tool body and rotatable around the tool body hole about the first axis, the blade carriage having a blade carriage hole extending therethrough along the first axis and a blade recess; a blade having a cutting portion and a tang shaped to fit in the blade recess, the tang including a notch; and a pin configured to be selectively removed from the tool body hole and the blade carriage hole along the first axis, wherein the pin includes: an elongated body having: a first outer diameter; a first end; and a second end opposite the first end; a pin head disposed near the first end of the elongated body, wherein the pin head is configured to engage with the tool body when the pin is positioned extending through the tool body hole and the blade carriage hole; a ball plunger disposed in the first outer diameter of the elongated body at the second end, wherein the ball plunger prevents the pin from being removed from the tool body hole and the blade carriage hole when the pin is positioned extending through the tool body hole and the blade carriage hole; and a pull ring disposed on the pin head; wherein: the pin is removable from the tool body hole and the blade carriage hole by displacing the ball plunger of the pin and pulling the pull ring along the first axis; and when the pin is removed from the tool body hole and the blade carriage hole, the blade is released from the blade carriage and can be removed.

10. The quick release mechanism of paragraph 9, wherein the second outer diameter of the pin head is greater than the first outer diameter of the elongated body of the pin.

11. The quick release mechanism of paragraphs 9-10, wherein when the pin is positioned extending through the blade carriage hole, the pin engages the notch of the tang to secure the blade to the blade carriage.

12. The quick release mechanism of paragraphs 9-11, further comprising a retaining plate coupled to the blade carriage and rotatable about the first axis, wherein the retaining plate includes a retaining plate hole extending therethrough along the first axis; wherein the tool body includes a concentric boss feature extending from the tool body around the tool body hole having: a first raised surface extending around the tool body hole having an inner diameter configured to receive the pin along the first axis and an outer diameter; and a second raised surface extending around the first raised surface; wherein: the retaining plate hole engages with the outer diameter of the first raised surface to support the blade carriage when the pin is removed from the tool body hole and blade carriage hole; and the second raised surface laterally supports the retaining plate and blade carriage when the pin is removed from the tool body hole and blade carriage hole.

13. The quick release mechanism of paragraphs 9-12, wherein elongated body of the pin is received by the tool body hole, the blade carriage hole, and the inner diameter of the first raised surface of the concentric boss feature and engages with the notch of the blade to secure the blade to the blade carriage.

14. The quick release mechanism of paragraphs 9-13, wherein the ball plunger disposed on the pin is displaced when the pin is pushed along the first axis from the second end.

15. The quick release mechanism of paragraphs 9-14, wherein the ball plunger disposed on the pin is displaced by pulling the pull ring along the first axis to remove the pin from the tool body hole and the blade carriage hole.

16. A method of changing a blade in a pipe cutting tool, the method comprising: moving a pin along a first axis from a locked position to a removed position, wherein in the locked position, the pin extends through a pipe cutting tool having: a tool body having a handle portion and a blade carrying portion, the blade carrying portion including a tool body hole extending therethrough along the first axis; a blade carriage coupled to the tool body and rotatable around the hole of the tool body, the blade carriage having a blade carriage hole extending therethrough along the first axis and a blade recess; a blade having a cutting portion and a tang shaped to fit in the blade recess, the tang including a notch; and a boss feature extending from the tool body around the tool body hole; wherein the pin is configured to removably extend through the tool body hole and the blade carriage hole, wherein: when the pin is positioned in the locked position, the pin engages the notch of the tang to secure the blade to the blade carriage; when the pin is in a removed position, the blade is released from the blade carriage and can be removed; and the boss feature extends from the tool body hole and engages the blade carriage so that the blade carriage is secured to the tool body when the pin is removed from the hole; removing the blade from the blade carriage by moving the blade along a second axis orthogonal to the first axis; placing a second blade in the blade carriage by moving the second blade along the second axis orthogonal to the first axis; and moving the pin along the first axis to the locked position to secure the blade to the blade carriage.

17. The method of paragraph 16, wherein prior to moving the pin along the first axis, the blade and blade carriage is rotated to an unlocked position.

18. The method of paragraphs 16-17, wherein removing the pin comprises displacing a ball plunger disposed near a first end of the pin from a radially extended position to a radially retracted position; wherein displacing the ball plunger to the radially retracted position allows the pin to be removed from pipe cutting tool; and wherein the ball plunger of the pin is displaced from the radially extended position to the radially retracted position by applying a longitudinal force to a pull ring disposed near a second end of the pin.

19. The method of paragraphs 16-18, wherein when the pin is removed from the pipe cutting, the boss feature is configured to support the blade carriage by engaging with a retaining plate coupled to the blade carriage and having a retaining plate hole extending therethrough along the first axis.

20. The method of paragraphs 18-19, wherein, after moving the pin to the locked position, the ball plunger returns to the radially extended position to secure the blade to the blade carriage.

While the foregoing is directed to embodiments of the present disclosure, other and further embodiments of the disclosure may be devised without departing from the basic scope thereof, and the scope thereof is determined by the claims that follow.

What is claimed is:

1. A pipe cutting tool, comprising:
a tool body having a handle portion and a blade carrying portion, the blade carrying portion including a tool body hole extending therethrough;
a blade carriage coupled to the tool body and rotatable around the tool body hole, the blade carriage having a blade carriage hole extending therethrough and a blade recess;
a blade having a cutting portion and a tang shaped to fit in the blade recess, the tang including a notch;
a boss feature extending from the tool body around the tool body hole; and
a pin configured to removably extend through the tool body hole and the blade carriage hole, wherein:
when the pin is positioned extending through the blade carriage hole, the pin engages the notch of the tang to secure the blade to the blade carriage;
when the pin is removed from the blade carriage hole, the blade is released from the blade carriage and can be removed; and
the boss feature engages the blade carriage so that the blade carriage is held in place in the tool body when the pin is removed from the blade carriage hole.

2. The pipe cutting tool of claim 1, wherein the notch of the blade is formed along an outer edge of the blade.

3. The pipe cutting tool of claim 1, wherein the notch of the blade comprises a hole spaced from the outer edge of the blade.

4. The pipe cutting tool of claim 1, further comprising a retaining plate coupled to the blade carriage and rotatable around the tool body hole, the retaining plate having a retaining plate hole extending therethrough, wherein the boss feature extends into the retaining plate hole to engage the blade carriage.

5. The pipe cutting tool of claim 4, wherein the boss feature comprises:
a raised surface extending from the blade carrying portion of the tool body around the tool body hole;
an inner diameter configured to receive the pin when the pin is positioned extending through the tool body hole; and
an outer diameter;
wherein:
the retaining plate hole is configured to receive the outer diameter of the boss feature; and
the raised surface of the boss feature is configured to engage the blade carriage to support the blade carriage when the pin is removed from the pipe cutting tool.

6. The pipe cutting tool of claim 1, further comprising:
a second handle portion rotatably coupled to the blade carrying portion of the tool body, further comprising:
a drive pawl; and
a holding pawl;
wherein the drive pawl and the holding pawl are configured to engage with a plurality of teeth disposed on the blade carriage to incrementally rotate the blade towards a closed position.

7. The pipe cutting tool of claim 6, wherein the holding pawl is configured to disengage from the plurality of teeth when the second handle portion is rotated away from the handle portion of the tool body to a reset position;
wherein, when the holding pawl is disengaged from the plurality of teeth, the blade and blade carriage are configured to rotate within the tool body to an open position.

8. The pipe cutting tool of claim 1, wherein the pin includes:
an elongated body having:
a first outer diameter;
a first end; and
a second end opposite the first end;
a pin head disposed at the first end of the elongated body and configured to engage with the tool body when the pin is positioned extending through the tool body hole and the blade carriage hole, wherein the pin head has a second outer diameter greater than the first outer diameter;
a ball plunger disposed in the first outer diameter of the elongated body near the second end, wherein the ball plunger is configured to prevent the pin from being removed from the blade carriage hole when the pin is positioned extending through the tool body hole and the blade carriage hole; and
a pull ring disposed on the pin head.

9. A quick release mechanism for a pipe cutting tool, the quick release mechanism comprising:
a tool body having a handle portion and a blade carrying portion, the blade carrying portion including a tool body hole extending therethrough along a first axis;
a blade carriage coupled to the tool body and rotatable around the tool body hole about the first axis, the blade carriage having a blade carriage hole extending therethrough along the first axis and a blade recess;
a blade having a cutting portion and a tang shaped to fit in the blade recess, the tang including a notch; and
a pin configured to be selectively removed from the tool body hole and the blade carriage hole along the first axis, wherein the pin includes:
an elongated body having:
a first outer diameter;
a first end; and
a second end opposite the first end;
a pin head disposed near the first end of the elongated body, wherein the pin head is configured to engage with the tool body when the pin is positioned extending through the tool body hole and the blade carriage hole;
a ball plunger disposed in the first outer diameter of the elongated body at the second end, wherein the ball plunger prevents the pin from being removed from the tool body hole and the blade carriage hole when the pin is positioned extending through the tool body hole and the blade carriage hole; and
a pull ring disposed on the pin head;
wherein:
the pin is removable from the tool body hole and the blade carriage hole by displacing the ball plunger of the pin and pulling the pull ring along the first axis; and
when the pin is removed from the tool body hole and the blade carriage hole, the blade is released from the blade carriage and can be removed.

10. The quick release mechanism of claim 9, wherein the second outer diameter of the pin head is greater than the first outer diameter of the elongated body of the pin.

11. The quick release mechanism of claim 10, wherein when the pin is positioned extending through the blade carriage hole, the pin engages the notch of the tang to secure the blade to the blade carriage.

12. The quick release mechanism of claim 9, further comprising a retaining plate coupled to the blade carriage and rotatable about the first axis, wherein the retaining plate includes a retaining plate hole extending therethrough along the first axis;
wherein the tool body includes a concentric boss feature extending from the tool body around the tool body hole having:
a first raised surface extending around the tool body hole having an inner diameter configured to receive the pin along the first axis and an outer diameter; and
a second raised surface extending around the first raised surface;
wherein:
the retaining plate hole engages with the outer diameter of the first raised surface to support the blade carriage when the pin is removed from the tool body hole and blade carriage hole; and
the second raised surface laterally supports the retaining plate and blade carriage when the pin is removed from the tool body hole and blade carriage hole.

13. The quick release mechanism of claim 12, wherein elongated body of the pin is received by the tool body hole, the blade carriage hole, and the inner diameter of the first raised surface of the concentric boss feature and engages with the notch of the blade to secure the blade to the blade carriage.

14. The quick release mechanism of claim 9, wherein the ball plunger disposed on the pin is displaced when the pin is pushed along the first axis from the second end.

15. The quick release mechanism of claim 14, wherein the ball plunger disposed on the pin is displaced by pulling the pull ring along the first axis to remove the pin from the tool body hole and the blade carriage hole.

16. A method of changing a blade in a pipe cutting tool, the method comprising:
moving a pin along a first axis from a locked position to a removed position, wherein in the locked position, the pin extends through a pipe cutting tool having:
a tool body having a handle portion and a blade carrying portion, the blade carrying portion including a tool body hole extending therethrough along the first axis;
a blade carriage coupled to the tool body and rotatable around the hole of the tool body, the blade carriage having a blade carriage hole extending therethrough along the first axis and a blade recess;
a blade having a cutting portion and a tang shaped to fit in the blade recess, the tang including a notch; and
a boss feature extending from the tool body around the tool body hole;
wherein the pin is configured to removably extend through the tool body hole and the blade carriage hole, wherein:
when the pin is positioned in the locked position, the pin engages the notch of the tang to secure the blade to the blade carriage;
when the pin is in a removed position, the blade is released from the blade carriage and can be removed; and
the boss feature extends from the tool body hole and engages the blade carriage so that the blade carriage is secured to the tool body when the pin is removed from the hole;
removing the blade from the blade carriage by moving the blade along a second axis orthogonal to the first axis;
placing a second blade in the blade carriage by moving the second blade along the second axis orthogonal to the first axis; and
moving the pin along the first axis to the locked position to secure the blade to the blade carriage.

17. The method of claim 16, wherein prior to moving the pin along the first axis, the blade and blade carriage is rotated to an unlocked position.

18. The method of claim 16, wherein removing the pin comprises displacing a ball plunger disposed near a first end of the pin from a radially extended position to a radially retracted position;
wherein displacing the ball plunger to the radially retracted position allows the pin to be removed from pipe cutting tool; and
wherein the ball plunger of the pin is displaced from the radially extended position to the radially retracted position by applying a longitudinal force to a pull ring disposed near a second end of the pin.

19. The method of claim 16, wherein when the pin is removed from the pipe cutting, the boss feature is configured to support the blade carriage by engaging with a retaining plate coupled to the blade carriage and having a retaining plate hole extending therethrough along the first axis.

20. The method of claim 18, wherein, after moving the pin to the locked position, the ball plunger returns to the radially extended position to secure the blade to the blade carriage.
